(19) United States
(12) Patent Application Publication
(10) Pub. No.: US 2002/0032292 A1
(43) Pub. Date: Mar. 14, 2002

(54) Fluoroelastomer and production thereof

(76) Inventors: Sunao Ikeda, Kitaibaraki-shi (JP); Satoru Saito, Kitaibaraki-shi (JP)

Correspondence Address: WEBB ZIESENHEIM LONGSDON ORKIN & HANSON, P.C., 700 Koppers Building, 436 Seventh Avenue, Pittsburgh, PA, 15219-1818, US

(21) Appl. No.: 09/898,929

(22) Filed: Jul. 3, 2001

Related U.S. Application Data
(63) Continuation-in-part of application No. 09/498,165, filed on Feb. 4, 2000.

(30) Foreign Application Priority Data
Feb. 5, 1999 (JP) 28223/1999

(51) Int. Cl. C08F 114/18

(52) U.S. Cl. 526/242; 526/247

(57) ABSTRACT

A fluoroelastomer obtained by polymerizing (a) tetrafluoroethylene, (b) a perfluoro (alkyl vinyl) ether and (c) a cyano group containing perfluorovinyl ether, in the presence of a brominated compound represented by the general formula:

RBrₙ

wherein R represents a fluorocarbon group having 1 to 8 carbon atoms, and n is an integer of 1 or 2. This fluoroelastomer can have relatively low molecular weight and low viscosity because the polymerization thereof is performed with the use of the brominated compound which functions as a chain transfer agent. That is, the flouroelastomer can exhibit improved rollability, extrudability and sheeting flow to thereby have excellent moldability and processability while ensuring excellent heat resistance and chemical resistance. The fluoroelastomer with these excellent properties can be produced safely with economic advantage because of the use of a relatively stable and inexpensive brominated compound as a chain transfer agent.

### CROSS-REFERENCE TO RELATED APPLICATION

This application is a continuation-in-part of U.S. application Ser. No. 09/498,165, filed Feb. 4, 2000, and entitled “Fluoroelastomer and Production Thereof.”

### BACKGROUND OF THE INVENTION

1. Field of the Invention

The present invention relates to a fluoroelastomer obtained by polymerizing tetrafluoroethylene, a perfluoro (alkyl vinyl) ether and a cyano group containing perfluorovinyl ether and relates to a process for producing the fluoroelastomer. More particularly, the present invention relates to a fluoroelastomer having excellent processability, obtained by polymerizing these monomers in the presence of a brominated compound and relates to a process for producing the fluoroelastomer.

2. Brief Description of the Prior Art

Various fluoroelastomers obtained by polymerizing tetrafluoroethylene, a perfluoro (alkyl vinyl) ether and a cyano group containing perfluorovinyl ether have been proposed as described in, for example, U.S. Pat. Nos. 3,546,186; 3,114,778; 3,852,326; 3,933,767; 4,138,426; 4,281,092 and Japanese Patent Application No. 6(1994)-295548.

Desirable shaped items can be formed by curing these fluoroelastomers with the use of a curing agent such as tetraphenyltin or 2,2-bis(3-amino-4-hydroxyphenyl)hexafluoropropane. The thus obtained shaped items have excellent heat resistance and chemical resistance, so that they are widely employed in fields such as the chemical, aircraft and semiconductor industries.

However, these conventional fluoroelastomers have a drawback in that the viscosity thereof is generally so high that incorporation of compounding agents and molding are difficult and their processability is poor.

Therefore, there is a demand for a fluoroelastomer having improved processability.

In this situation, International Application PCT/US90/02604 published as WO 90/14368 proposed producing a fluoroelastomer of low viscosity by performing polymerization in the presence of an iodinated compound of the formula RIₙ (wherein R represents a hydrocarbon or a halocarbon group or hydrocarbon having 1 to 8 carbon atoms, and n is 1 or 2) employed as a chain transfer agent.

However, this iodinated compound has a drawback in that it is unstable when exposed to heat or light to cause handling thereof to be difficult, and further, it is expensive. Moreover, there is the problem that ICF₂CF₂I as a starting material of this iodinated compound is a substance of extremely high toxicity. Therefore, there has been a strong demand for the development of a process which enables producing a fluoroelastomer safely with economic advantage by the use of a chain transfer agent being so stable as to facilitate procurement and handling thereof.

### SUMMARY OF THE INVENTION

In one aspect of the present invention, there is provided a fluoroelastomer obtained by polymerizing:

a) tetrafluoroethylene,

b) a perfluoro (alkyl vinyl) ether, and

c) a cyano group containing perfluorovinyl ether, in the presence of a brominated compound represented by the general formula:

RBrₙ (I)

wherein R represents a fluorocarbon group having 1 to 8 carbon atoms, and n is an integer of 1 or 2.

In another aspect of the present invention, there is provided a process for producing a fluoroelastomer, which comprises polymerizing:

a) tetrafluoroethylene,

b) a perfluoro (alkyl vinyl) ether, and

c) a cyano group containing perfluorovinyl ether, in the presence of a brominated compound represented by the general formula:

RBrₙ (I)

wherein R represents a fluorocarbon group having 1 to 8 carbon atoms, and n is an integer of 1 or 2.

The present invention provides a fluoroelastomer having excellent moldability and processability, obtained by polymerizing tetrafluoroethylene, a perfluoro (alkyl vinyl) ether and a cyano group containing perfluorovinyl ether in the presence of a specified compound.

In particular, the present invention provides a fluoroelastomer having excellent moldability and processability, obtained by performing the polymerization in the presence of a highly safe and economically advantageous chain transfer agent.

### DETAILED DESCRIPTION OF THE PREFERRED EMBODIMENT

The present invention will be described in detail below.

The fluoroelastomer of the present invention is obtained by copolymerizing monomers comprising (a) tetrafluoroethylene (hereinafter also simply referred to as “monomer (a)” or “TFE”), (b) a perfluoro (alkyl vinyl) ether (hereinafter also simply referred to as “monomer (b)”) and (c) a cyano group containing perfluorovinyl ether (hereinafter also simply referred to as “monomer (c)”) in the presence of a specified compound.

The specified compound for use in the present invention is a brominated compound represented by the general formula:

RBrₙ (I)

wherein R represents a fluorocarbon group having 1 to 8 carbon atoms, and n is an integer of 1 or 2.

With respect to the above monomers, any of those whose alkyl group has 1 to 5 carbon atoms can preferably be used a the monomer (b), viz. perfluoro (alkyl vinyl) ether (PAVE). Specifically, perfluoro (methyl vinyl) ether (PMVE), perfluoro (ethyl vinyl) ether and perfluoro (propyl vinyl) ether are still preferably used, and perfluoro (methyl vinyl) ether is especially preferably used as the monomer (b).

Furthermore, perfluoro (alkoxyalkyl vinyl) ethers can also be used as the monomer (b), viz. perfluoro (alkyl vinyl) ether.

For example, those represented by the general formulae:

CF₂═CFOCF₂CF(CF₃)OCₙF₂₊₁ (n: 1-5),

CF₂═CFO(CF₂)₃OCₙF₂₊₁ (n: 1-5),

CF₂═CFOCF₂CF(CF₃)O(CF₂O)ₘCₙF₂ₙ₊₁ (n: 1-5 and m: 1-3), and

CF₂═CFO(CF₂)₂CₙF₂₊₁ (n: 1-5)

Can preferably be used as the perfluoro (alkoxyalkyl vinyl) ether.

Further, with respect to the above monomers, for example, those represented by the general formulae:

CF₂═CFO(CF₂)ₙCN (n: 2-4)

CF₂═CFO[CF₂CF(CF₃)O]ₙCF₂CF(CF₃)CN (n: 0-4)

CF₂═CFO[CF₂CF(CF₃)O]ₘ(CF₂)ₙCN (n: 1-4 and m: 1-2), and

CF₂═CFO(CF₂)ₙOCF(CF₃)CN (n: 2-4)

Can be preferably be used as the cyano group containing perfluorovinyl ether (c).

The fluoroelastomer of the present invention is obtained by copolymerizing the above monomers (a), (b) and (c) in the presence of specified compound Rbrₙ. Although the respective amounts of monomers (a), (b) and (c) used in the copolymerization are not particularly limited as long as the fluoroelastomer being a copolymerizate of the monomers (a), (b) and (c) can be obtained, it is preferred that the amounts be such that the obtained fluoroelastomer comprises 50 to 75 mol %, especially 60 to 75 mol %, of structural units derived from tetrafluoroethylene (a), 24.8 to 49.8 mol %, especially 24.8 to 39.8 mol %, of structural units derived from perfluoro (alkyl vinyl) ether (b) and 0.2 to 5 mol %, especially 0.2 to 2 mol %, of structural units derived from cyano group containing perfluorovinyl ether (c).

In the present invention, the above monomers are copolymerized in the presence of a brominated compound represented by the general formula:

RBrₙ (I)

wherein R represents a fluorocarbon group having 1 to 8 carbon atoms, and n is an integer of 1 or 2.

In the present invention, although all the brominated compounds represented by the general formula (I) can suitably be used, it is preferred that R representS a saturated fluorocarbon residue of chlorofluorocarbon residue. For example, use can be made of monobromoperfluoromethane, dibromodifluoromethane, monobromoperfluoroethane, 1,2-dibromoethane, monobromoperfluoropropane, 1,3-dibromoperfluoro-n-propane, 1,4-dibromoperfluoro-n-butane, 1,3-dibromo-2-chloroperfluoro-n-propane and 1,5-dibromo-2,4-dichloroperfluoro-n-pentane. Of these, dibromodifluoromethane is most especially preferred.

The loading of these brominated compounds, although varied depending on the type of monomer and the reaction conditions, is appropriate as long as it an amount sufficient to induce a chain transfer in the copolymerization reaction. When the bromine concentration is extremely high, the obtained copolymer has an unfavorably small molecular weight and an unfavorably low viscosity to thereby cause poor moldability. Specifically, it is preferred that the brominated compound be added in an amount of 0.05 to 1.0 mol %, especially 0.1 to 0.5 mol %, based on the total amount of charged monomers (a), (b) and (c).

In the present invention, the brominated compound can be rendered suitably coexistent in the copolymerization reaction system by, for example, directly adding the brominated compound to the reaction system or feeding it as a solvent.

In the present invention, although the copolymerization reaction of the above monomers can be performed by any of customary polymerization techniques such as emulsion, suspension and bulk polymerizations, performing the copolymerization reaction by the emulsion polymerization technique is preferred from the viewpoint that a copolymer of high polymerization degree can be obtained with economic advantage.

When the copolymerization is performed by the emulsion polymerization reaction, it is preferred that a water-soluble inorganic peroxide such as ammonium persulfate or a redox thereof with a reducing agent be used as a catalyst, and that ammonium perfluorooctanoate, ammonium perfluoroheptanoate, ammonium perfluorononanoate or a mixture thereof, especially ammonium perfluorooctanoate, be used as an emulsifier. With respect to the reaction conditions, it is generally preferred that the pressure be in the range of about 0 to 100 kg/cm²G, especially about 0 to 50 kg/cm²G, and that the temperature be in the range of about 0 to 100° C., especially 20 to 80° C. Further, in the copolymerization, an electrolyte having buffering capacity such as Na₂HPO₄, NaH₂PO₄ or KH₂PO₄, may be added to the polymerization system in order to regulate the pH value thereof.

The fluoroelastomer of the present invention, if desired, may be loaded with a curing agent before use. Use can be made of known curing agents as described in, for example, Japanese Patent Laid-Open Publication Nos. 9(1997)-111081 and 9(1997)-31284 and Japanese Patent Publication No. 2(1990)-59177. Specific examples thereof include 2-bis (diaminophenyl) compounds, bis(aminophenol) compounds, ammonium salts of organic acids, ammonium salts of inorganic acids and bisamidrazone compounds. These curing agents are preferably used in an amount of about 0.2 to 5 parts by weight, still preferably about 0.5 to 3 parts by weight, per100 parts by weight of fluoroelastomer composition.

The thus obtained fluoroelastomer of the present invention has a small molecular weight and low viscosity and is excellent in moldability and processability as compared with those of fluoroelastomers obtained by the conventional polymerization methods in which the brominated compound is not employed.

The fluoroelastomer of the present invention preferably exhibits an intrinsic viscosity ηₛₚ/c of 0.1 to 0.6 dl/g, still preferably 0.1 to 0.4 dl/g, the intrinsic viscosity ηₛₚ/c measured at 25° C. and at a resin concentration of 0.1 g/100 ml of solvent, the solvent being a solution consisting of a 40:60:3 (volume ratio) mixture of perfluoro (2-butyltetrahydrofuran), 2,3,3-trichloroheptafluorobutane and ethylene glycol dimethyl ether.

Furthermore, the fluoroelastomer of the present invention, if desired, may be loaded with various additives. Examples of the additives include, besides the above curing agent, an inorganic filler such as carbon black or silica, an oxide or hydroxide of divalent metal such as lead oxide, zinc oxide, magnesium oxide or calcium hydroxide, an acid receptive agent such as a stearic acid salt or hydrotalcite, and any of various pigments, processing auxiliaries and plasticizers.

Compositions comprising the fluoroelastomer of the present invention loaded with additives and the like are preferably prepared by kneading with the use of, for example, a roll mill, a kneader or a Banbury mixer at a temperature which, although depending on the properties of the fluoroelastomer and the formulation of additives and the like, is in the range of about 30 to 100° C. curing of the prepared fluoroelastomer compositions is preferably preformed by heating with the use of, for example, a compression molding machine at about 150 to 220° C. for about 5 to 60 min, although depending on the properties of composition. Postcuring can be performed, which can preferably be effected by heating in an inert atmosphere such as a nitrogen atmosphere or air, especially an inert atmosphere, at about 200 to 300° C. for about 10 to 50 hr.

In the present invention, the fluoroelastomer is obtained by copolymerizing the monomers (a), (b) and (c) with the use of the brominated compound which functions as a chain transfer agent, so that the fluoroelastomer of relatively low molecular weight and low viscosity can be provided. That is, the present invention provides the fluoroelastomer which exhibits improved rollability, extrudability and sheeting flow to thereby have excellent moldability and processability while ensuring excellent heat resistance and chemical resistance. Moreover, the fluoroelastomer with these excellent properties can be produced safely with economic advantage because of the use of a relatively stable and inexpensive brominated compound as a chain transfer agent.

### EXAMPLE

The present invention will further be illustrated below with reference to the following Examples which in no way limit the scope of the invention.

In the Examples and Comparative Example, the evaluations are made by the following methods.

<Evaluation Method>

Intrinsic Viscosity nₛₚ/c

Measured at 25° C. and at a resin concentration of 0.1 g/100 ml solvent, the solvent being a solution consisting of a 40:60:3 (volume ratio) mixture of perfluoro (2-butyltetrahydrofuran), 2,3,3-trichloroheptafluorobutane and ethylene glycol dimethyl ether.

Torque Value (ML)

Measured at 170° C. with the use of Curelastmeter.

Compression Set

Measured in accordance with ASTM D-395, Method B, in which O-ring (P-24) is applied to specimen at 300° C. for 70 hr.

Extrudability

Extrusion forming is performed under conditions such that:

Cylinder temperature: 120° C.

Head temperature: 140° C.

Screw rotating speed: 40 rpm,

Diameter: 25 mm,

L/D (375 mm/25 mm): 15,

Compression ratio: 1.2, and

Die diameter: 3.5 mm. The pressure in the cylinder is measured and the extrudability is evaluated.

Polymer Mooney Viscosity (PML₁₊₁₀)

Measured in accordance with Japanese Industrial Standard (JIS) K6300.

TC10, TC90

measured in accordance with JIS K6300.

### Example 1

<Production of Fluoroelastomer>

1600 ml of distilled water, 54.6 g of ammonium perfluorooctanoate as an emulsifier, 23.7 g of potassium dihydrogen phosphate and 0.7 g of dibromodifluoromethane (CF₂Br₂) as a brominated compound were charged into a deaerated steel autoclave of 3 lit. volume. The amount of charged dibromodifluoroethane corresponded to 0.1 mol % of the total amount of monomers charged as mentioned below.

Subsequently, a monomer mixture was prepared, which consisted of:

26 g of tetrafluoroethylene (TFE) (a),

43 g of perfluoro (methyl vinyl) ether (PMVE) (b), and

5 g of CF₂═CFO(CF₂)₃OCF(CF₃)CN (CEPVE) (c). In this mixture, the mixing ratio of monomer (a)/monomer (b)/monomer (c) was 48.9/48.7/2.4 (mol %).

The internal temperature of the autoclave was raised to 60° C., and the above monomer mixture was fed until the internal pressure was raised to about 0.9 MPa. 50 ml of an aqueous solution having 9.0 g of ammonium persulfate and 1.7 g of sodium sulfite dissolved therein was injected thereinto under pressure, thereby, initiating a copolymerization reaction.

In the course of the reaction, when the internal pressure of the reaction system became 0.85 MPa, the above monomer mixture was added so that the internal pressure was raised to 0.9 MPa. This procedure was repeated. After the completion of the charging of the total amount of the above monomer mixture, the polymerization reaction was continued until the internal pressure of the reaction system was lowered to about 0.65 MPa. Thus, a copolymer was obtained.

The thus obtained copolymer was placed in an aqueous solution of sodium chloride and coagulated. The coagulated copolymer was washed with water and dried. Thus, 379 g of fluoroelastomer was obtained. The rate of polymerization was 86%. The properties of the obtained fluoroelastomer are listed in Table 1.

<Production of Cured Molding>

The thus obtained fluoroelastomer was loaded with the following compounding agents, blended together by means of a twin-roll rubber mill and compression molded at a curing temperature of 180° C. Thus, a cured molding was obtained.

The compounding agents consisted of, per 100 parts by weight of fluoroelastomer, p 0.6 part by weight of bisamidrazone of 2,2-bis(4-carboxyphenyl)hexafluoropropane of the formula:

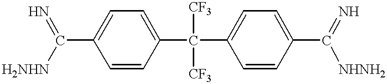

2 parts by weight of ZnO, and

20 parts by weight of carbon black.

<Production of Cured Product>

The thus obtained cured molding was further subjected to oven curing in a nitrogen atmosphere under the following heating conditions.

Heating Conditions for Oven Curing

Temperature was

1) maintained at 90° C. for 4 hr,

2) raised to 204° C. over a period of 6 hr,

3) maintained at 204° C. for 18 hr,

4) raised to 288° C. over a period of 6 hr,

5) maintained at 288° C. for 18 hr, and

6) lowered to 100° C. over a period of 3 hr.

The properties of the resultant cured product were evaluated. The results are given in Table 1.

### Example 2

Fluoroelastomer was produced in the same manner as in Example 1, except that the amount of dibromodifluoromethane (CF₂Br₂) was changed to 2.0 g (corresponding to 0.29 mol % of the total amount of charged monomers). The properties thereof are listed in Table 1.

The obtained fluoroelastomer was cured and oven cured, and the properties thereof were evaluated in the same manner as in Example 1. The results are given in Table 1.

### Example 3

Fluoroelastomer was produced in the same manner as in Example 1, except that the amount of dibromofluoromethane (CF₂Br₂) was changed to 4.0 g (corresponding to 0.56 mol % of the total amount of charged monomers). The properties thereof are listed in Table 1.

The obtained fluoroelastomer was cured and oven cured, and the properties thereof were evaluated, in the same manner as in Example 1. The results are given in Table 1.

### Example 4

Fluoroelastomer was produced in the same manner as in Example 1, except that the amount of ammonium persulfate was changed to 2.0 g and the amount of sodium sulfate was changed to 0.36 g in the 50 ml of aqueous solution. The properties thereof are listed in Table 1.

The obtained fluoroelastomer was cured and oven cured, and the properties thereof were evaluated in the same manner as in Example 1. The results are given in Table 1.

### Comparative Example 1

Fluoroelastomer was produced in the same manner as in Example 1, except that dibromodifluoromethane (CF₂Br₂) was not used. The properties thereof are listed in Table 1.

The obtained fluoroelastomer was cured and oven cured, and the properties thereof were evaluated in the same manner as in Example 1. The results are given in Table 1.

NEW TABLE 1

| | | | | | Comp. |
|---|---|---|---|---|---|
| | Exam- | Exam- | Exam- | Exam- | Exam- |
| | ple 1 | ple 2 | ple 3 | ple 4 | ple 1 |
| <Characteristics of | | | | | |
| Fluoroelastomer> | | | | | |
| [Amt. of CF₂Br₂ used] | 0.1 | 0.29 | 0.56 | 0.29 | 0 |
| (mol % based on total | | | | | |
| amt. of monomer | | | | | |
| charged) | | | | | |
| [Compsn.] | | | | | |
| TFE (mol %) | 66.2 | 64.9 | 65.6 | 64.5 | 64.0 |
| PMVE (mol %) | 32.3 | 33.6 | 32.8 | 33.9 | 34.5 |
| CEPVE (mol %) | 1.5 | 1.5 | 1.6 | 1.6 | 1.5 |
| [Intrinsic visc.] | | | | | |
| (ηₛₚ/c) | 0.59 | 0.48 | 0.32 | 0.24 | 1.07 |
| [PML_{1+1c]} | | | | | |
| (150° C.) | 106 | 85 | 37 | 27 | 150 |
| <Curing | | | | | |
| Characteristics> | | | | | |
| [Min. Torque (M_{L})] | 4.7 | 3.0 | 1.8 | 2.0 | 7.2 |
| (kg − m) | | | | | |
| [TC10] | 2.82 | 1.58 | 2.02 | 1.52 | 1.14 |
| (min.) | | | | | |
| [TC90] | 16.30 | 14.56 | 16.16 | 17.46 | 15.78 |
| (min.) | | | | | |
| [Compression set] | 52 | 52 | 62 | 42 | 46 |
| (275° C./70 hr) | | | | | |
| [Extrudability] | good | good | good | good | poor |
| Pressure in cylinder] | 80 | 50 | 35 | 40 | >200 |
| (kg/cm²) | | | | | |

As apparent from the above results, the Examples 1-4 in which the brominated compound was employed as a chain transfer agent enabled obtaining a fluoroelastomer of low viscosity having excellent moldability as compared with that of the Comparative Example 1 in which polymerization was performed in the absence of any brominated compound. Furthermore, the fluoroelastomers obtained in Examples 1-4 exhibited excellent moldability even at the time of curing.

We claim:

1. A fluoroelastomer obtained by polymerizing a composition comprised of:
a.) 50 to 75 mol % tetrafluoroethylene,
b.) 24.8 to 49.8 mol % of a perfluoro (alkyl vinyl) ether, and
c.) 0.2 to 5 mol % of a cyano group containing perfluorovinyl ether, in the presence of dibromodifluoromethane,
wherein the resulting resin has an intrinsic viscosity ηₛₚ/c of 0.1 to 0.4 dl/q measured at 25° C. and concentration of 0.1 g/100 ml solvent, the solvent being a solution consisting of a 40:60:3 (volume ratio) mixture of perfluoro (2-butyltetrahydrofuran), 2,3,3-trichlorheptafluorobutane and ethylene dimethyl ether.

2. The fluoroelastomer as claimed in claim 1, wherein the perfluoro (alkyl vinyl) ether (b) contains an alkyl group having 1 to 5 carbon atoms.

3. The fluoroelastomer as claimed in claim 1, wherein the cyano group containing perfluorovinyl ether is represented by the general formula:
CF₂═CFO(CF₂)ₙOCF(CF₃)CN
wherein n is an integer of 2 to 12.

4. The fluoroelastomer as claimed in claim 1, wherein the cyano group containing perfluorovinyl ether is represented by the general formula:
CF₂═CFO(CF₂)ₙCN
